(19) United States
(12) Patent Application Publication
(10) Pub. No.: US 2005/0279646 A1
(43) Pub. Date: Dec. 22, 2005

(54) Sensor and method of detecting a substance

(75) Inventors: Shinji Hasegawa, Ashigarakami-gun (JP); Kei Shimotani, Ashigarakami-gun (JP); Kentarou Kishi, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 11/000,428

(22) Filed: Dec. 1, 2004

(30) Foreign Application Priority Data
Jun. 21, 2004 (JP) 2004-182985

(51) Int. Cl. G01N 27/26

(52) U.S. Cl. 205/789; 205/792

(57) ABSTRACT

The present invention provides a sensor including an acidic medium; a first electrode disposed in the acidic medium; a basic medium adjacent to or close to the acidic medium; a second electrode disposed in the basic medium; and a detector for detecting one of voltage and current that is generated between the first and second electrodes by a first substance which causes a reaction of removing electrons from the first electrode with hydrogen ions contained in the acidic medium, and a second substance which causes a reaction of supplying electrons to the second electrode with hydroxide ions contained in the basic medium, and provides a method of detecting a substance using the sensor.

### CROSS-REFERENCE TO RELATED APPLICATION

This application claims priority under 35 USC 119 from Japanese Patent Application No. 2004-182985, the disclosure of which is incorporated by reference herein.

### BACKGROUND OF THE INVENTION

1. Field of the Invention

The present invention relates to a sensor and a method of detecting a substance which use a cell reaction of the substance.

2. Description of the Related Art

In recent years, research and development of sensors for detecting various substances have been actively carried out. In particular, a need for a sensor for detecting hydrogen peroxide is increasing for the purpose of detecting trace amounts of hydrogen peroxide that are introduced from a sterilizing liquid for food or a wrapping pack thereof into food and remains therein. In detecting biosubstances such as glucose, urea, and cholesterol, biosensors that detect hydrogen peroxide generated by an enzyme reaction of these biosubstances are often used, and thus sensors for detecting hydrogen peroxide can be widely used not only in the field of food but also in the field of medicine. There are numerous substances containing hydrogen peroxide, such as cleaning liquids for semiconductor processing and bleaching agents containing sodium percarbonate, close at hand, and thus a sensor that can easily and precisely detect hydrogen peroxide is strongly demanded.

Currently, in order to detect a certain specific substance, change in the following physical quantities is mainly used: (1) electricity, (2) light, and (3) heat. Detection signals of these are converted into electric signals for display or recordation. Accordingly, change in (1) electricity is convenient and is widely used in general because the detection signals can be directly used.

Examples of a practical method for detecting hydrogen peroxide include (1) a calorimetric method and (2) an electrochemical method.

In the calorimetric method (1), an ultraviolet-visible absorption spectrum is measured by using a reagent (titanium sulfate solution or Trinder's reagent) that reacts with hydrogen peroxide to form color, and the concentration of the colored reagent is measured by determining its absorbance thereof.

In the electrochemical method (2), attention is paid to a redox potential unique to hydrogen peroxide. This is a method in which exchange of electrons accompanying a redox reaction is measured by cyclic voltammetry, and in which the concentration of hydrogen peroxide is obtained from the value of a current at a certain potential. For example, there is a sensor that detects hydrogen peroxide by using an electrode having a surface on which ferrocene is fixed (see, for example, C. Padeste et. al., “Ferrocene-avidinconjugates for bioelectrochemical applications”, Biosensors & Bioelectronics, 2000, vol. 15, pp. 431-438).

However, the aforementioned hydrogen peroxide sensors involve the following problems. Namely, the calorimetric method (1) requires a large amount of a sample solution in order to raise sensitivity, since the detection sensitivity in the absorbance measurement is proportional to the length of the optical path of a measuring device. Therefore, it is difficult to apply the method to detection of a trace amount of a sample. Also, the absorbance measurement requires an optical measurement apparatus such as a spectrophotometer. On the other hand, the electrochemical method (2) requires an electrochemical measurement apparatus such as a cyclic voltammeter in measurement. In order to detect a trace amount of a sample with high sensitivity, the method also requires an expensive minute electrode such as a comb-type electrode. In both methods, it is necessary to use a complicated measurement system for concentration measurement having a high sensitivity and reliability. Therefore, a sensor and a detection method that can easily measure hydrogen peroxide with a simpler measurement unit is desired.

Also regarding conventional sensors for substances other than hydrogen peroxide, such as oxygen or alcohol, detection at a high sensitivity and a simpler measurement apparatus are incompatible with each other.

Therefore, there is a need for a sensor that has a simple construction and is capable of detecting a substance at a high precision, and a method of detecting a substance using the same.

### SUMMARY OF THE INVENTION

A sensor of the invention makes use of a cell reaction caused by a substance serving as a detection object. For example, the sensor detects the presence or absence of a substance by detecting voltage or current generated by the substance, or measures the voltage-current characteristic dependent on the concentration of the substance and determines the concentration on the basis of the measured value.

A first aspect of the invention provides a sensor for detecting, as at least one detection object substance, at least one of a first substance and a second substance, and the sensor includes: an acidic medium; a first electrode disposed in the acidic medium; a basic medium adjacent to or close to the acidic medium; a second electrode disposed in the basic medium; and a detector for detecting one of voltage and current that is generated between the first and second electrodes by the first substance which causes a reaction of removing electrons from the first electrode with hydrogen ions contained in the acidic medium, and the second substance which causes a reaction of supplying electrons to the second electrode with hydroxide ions contained in the basic medium.

In the sensor of the invention, an output (voltage or current) is generated even by a trace amount of a substance serving as a detection object, and detected by a detector having a simple construction (for example, a measurement unit such as a voltammeter). Therefore, the sensor can determine the presence or absence of the substance or can measure the concentration thereof with ease and at a high precision.

On the other hand, a second aspect of the invention provides a method of detecting a first substance and/or a second substance serving as a detection object or objects using the sensor of the invention.

### BRIEF DESCRIPTION OF THE DRAWINGS

Preferred embodiments of the invention will be described in detail based on the following figures, wherein:

FIG. 1 is a view illustrating an output mechanism (power generation method) of the sensor of the invention;

FIG. 2A is a top perspective view schematically showing a chip type sensor which is one embodiment of the sensor of the invention, and FIG. 2B is a cross-sectional view obtained by cutting the chip type sensor of FIG. 2A along the line A-A′;

FIG. 3 is a graph showing the current-voltage characteristics of the chip type sensor, obtained by using sample liquids of various hydrogen peroxide concentrations in Example 1;

FIG. 4 is an enlarged graph showing the current-voltage characteristics in a range where current density is low in FIG. 3;

FIG. 5 is a graph obtained by plotting closed-circuit current densities with respect to hydrogen peroxide concentrations in Example 1, and showing the calibration curve of the sensor;

FIG. 6 is a graph obtained by plotting closed-circuit current densities of specimens with respect to hydrogen peroxide concentrations in Example 1;

FIG. 7 is a graph showing the current-voltage characteristics obtained by using a chip type sensor to detect hydrogen peroxide concentrations in Example 2; and

FIG. 8 is a graph showing the current-voltage characteristics obtained by using the chip type sensor to show an effect of diluted acid and alkali in Example 3.

### DETAILED DESCRIPTION OF THE INVENTION

Hereafter, the invention will be described in detail.

Sensor

The sensor of the invention includes an acidic medium, a first electrode disposed in the acidic medium, a basic medium adjacent to or close to the acidic medium, a second electrode disposed in the basic medium, and a detector for detecting a voltage or a current that is generated by a detection object substance (substance serving as a detection object) between the first and second electrodes.

An article which is obtained by removing a detector from the sensor of the invention and which contains media including detection object substances (first and second substances) is a bipolar type cell including the above-described members other than the detector. The sensor can be applied to all types of cell, such as a primary cell, a secondary cell, and a fuel cell. Here, the bipolar type cell refers to a cell in which an acidic medium and a basic medium are adjacent to each other and which contains a substance for generating electric energy and electrodes.

In particular, in the bipolar type cell, (1) a first substance and hydrogen ions coexist in the acidic medium or near an electrode which is in contact with the acidic medium, serve as reactants and cause a reaction (oxidation) of removing electrons from the first electrode. Further, in the bipolar type cell, (2) a second substance and hydroxide ions coexist in the basic medium or near an electrode which is in contact with the basic medium, serve as reactants and cause a reaction (reduction) of supplying electrons to the second electrode. These reactions (1) and (2) simultaneously proceed to generate electric energy, which runs in an external circuit. The detector detects this electric energy, which is sensor operation of detecting the first substance and/or the second substance serving as a detection object substance or substances.

In the method of detecting a substance according to the invention, the sensor of the invention is used to detect a detection object substance.

Each member of the sensor of the invention will be described in detail.

Acidic and Basic Media

In the invention, the acidic medium has a pH value of less than 7, and preferably has a pH value of 3 or less, and is preferably capable of forming an acidic reaction field where hydrogen ions exist. The basic medium has a pH value of more than 7, and preferably has a pH value of 11 or more, and is preferably capable of forming a basic reaction field where hydroxide ions exist.

Each of the acidic and basic media may be in any form of liquid, gel, or solid. However, the two media are preferably in the same form. Further, each of the acidic and basic media can be an organic compound or an inorganic compound.

Typical examples of combinations of the acidic and basic media include a combination of an acidic aqueous solution of sulfuric acid, hydrochloric acid, or phosphoric acid, and a basic aqueous solution of sodium hydroxide, potassium hydroxide, ammonia, or an ammonium compound; a combination of ion-conductive gels obtained by gelatinizing the above solutions with a gelatinizer or gelatinizers; a combination of ion-exchange members (membranes or filter paper including ion exchange resins) such as a combination of an acidic ion-exchange member having a sulfonic group or a phosphoric group and a basic ion-exchange member having a quaternary ammonium group; and a combination of a solid super strong acid and a solid acid, such as zirconium oxide treated with sulfuric acid or zirconium oxide including a noble metal, and a solid super strong base and a solid base, such as barium oxide.

More specifically, the acidic aqueous solution preferably includes at least one of sulfuric acid, methanesolfonic acid, trifluoromethanesolfonic acid, hydrochloric acid, hydriodic acid, hydrobromic acid, percholoric acid, periodic acid, orthophosphoric acid, polyphosphoric acid, nitric acid, tetrafluoroboric acid, hexafluorosilic acid, hexafluorophosphoric acid, hexafluoroarsenic acid, hexachloroplatinic acid, acetic acid, trifluoroacetic acid, citric acid, oxalic acid, salicylic acid, tartaric acid, maleic acid, malonic acid, phthalic acid, fumaric acid, and picric acid. Among these, the acidic aqueous solution preferably includes sulfuric acid, hydrochloric acid, nitric acid, or phosphoric acid, which is strong acid.

Moreover, the basic aqueous solution preferably includes at least one base of sodium hydroxide, potassium hydroxide, lithium hydroxide, calcium hydroxide, barium hydroxide, magnesium hydroxide, ammonium hydroxide, tetramethylammonium hydroxide, tetraethylammonium hydroxide, tetrapropylammonium hydroxide, and tetrabutylammonium hydroxide, or at least one alkali metal salt of weak acid such as sodium carbonate, sodium hydrogen carbonate, potassium carbonate, potassium hydrogen carbonate, sodium borate, potassium borate, sodium silicate, potassium silicate, sodium tripolyphosphate, potassium tripolyphosphate, sodium aluminate, and potassium aliminate. Among these, the basic aqueous solution preferably includes sodium hydroxide or potassium hydroxide, which is strong base.

Further, the acidic ion-conductive gel serving as the acidic medium is preferably one obtained by gelatinizing the acidic aqueous solution with a gelatinizer such as water glass, anhydrous silicon dioxide, cross-linked polyacrylic acid, agar, or a salt thereof.

On the other hand, the basic ion-conductive gel serving as the basic medium is preferably one obtained by gelatinizing the basic aqueous solution with a gelatinizer, for example, carboxymethyl cellulose, cross-linked polyacrylic acid, or a salt thereof. One acid can be used, or at least two kinds of acids can be used together. Moreover, one base can be used, or at least two kinds of bases can be used together. Furthermore, one gelatinizer can be used, or at least two gelatinizers can be used together.

Further, examples of the acidic and basic ion-exchange members include an ion-exchange membrane, a solid polymer electrolyte membrane, and filter paper including ion-exchange resin. The acidic ion-exchange member is preferably an ion-exchange member including a strongly acidic ion-exchange resin with a strongly acidic group such as a sulfonic group or a phosphoric group, and the basic ion-exchange member is preferably a strongly basic ion-exchange member including a strongly basic ion-exchange resin with a strongly basic group such as a quaternary ammonium group.

Typical examples of commercially available products of the acidic and basic ion-exchange members include polyvinylstyrene ion-exchange resins such as Dowex™ manufactured by Dow Co., Ltd., Diaion™ manufactured by Mitsubishi Chemical Co., Ltd., and Amberlite™ manufactured by Rohm and Hass Co., Ltd.; polyfluorohydrocarbon polymer solid polymer electrolyte membranes such as Nafion™ manufactured by DuPont Co., Ltd., Flemion™ manufactured by Asahi Glass Co., Ltd., and Asiplex™ manufactured by Asahi Kasei Industry Co., Ltd.; polyvinylstyrene ion-exchange membranes such as Neosepta™ and Neosepta BP-1™ manufactured by Tokuyama Co., Ltd.; and ion-exchange filter paper RX-1™ manufactured by Toray Co., Ltd. and made of polystyrene fibrous ionex ion exchanger.

Furthermore, typical examples of the solid super strong acid include zirconium oxide treated with sulfuric acid, and zirconium oxide containing a noble metal. In addition, the solid acid can be clay mineral such as kaolinite or montmorillonite, zeolite, composite oxide, hydrated oxide, or activated carbon adsorbing an acidic substance.

Typical examples of the solid super strong base include barium oxide, strontium oxide, and calcium oxide. In addition, the solid base can be a metal oxide such as magnesium oxide, composite oxide containing metal oxides, hydroxide having a low solubility in water such as calcium hydroxide, alkali metal or alkaline earth metal ion-exchange zeolite, or activated carbon adsorbing a basic substance.

In the sensor of the invention, it is essential that the acidic medium and the basic medium are adjacent to or close to each other. This is necessary to cause a counter anion generated when the acidic medium releases hydrogen ions and a counter cation generated when the basic medium releases hydroxide ions to form a salt and necessary to balance negative charge with positive charge. For this reason, when the two media are, for example, an acidic aqueous solution and a basic aqueous solution as described above, these aqueous solutions may be separated from each other with a membrane which the resultant positive ions and/or negative ions can permeate, or a salt bridge in which the positive ions and/or negative ions can move.

In the sensor of the invention, the first substance can be any material (oxidizer) which causes an oxidation reaction (removing electrons from the first electrode) with hydrogen ions. However, the first substance is preferably a material which causes an oxidation reaction accelerated by a hydrogen-ion concentration being high. Typical examples of such a material include hydrogen peroxide, hydrogen, hydrazine, and alcohol.

Further, the second substance can be any substance (reducing agent) which causes a reduction reaction (supplying electrons to the second electrode) with hydroxide ions. However, the second substance is preferably a material which causes a reduction reaction accelerated by a hydroxide-ion concentration being high. Typical examples of such a material include hydrogen peroxide, hydrogen, hydrazine, and alcohol.

Further, the first or second substance can be a metal ion that can change its valence number by a redox reaction such as iron, manganese, chromium, or vanadium, or a metal complex thereof.

Among these, it is preferable that the first and second substances be the same component. Such a substance causes an oxidation reaction (removing electrons from the first electrode) with hydrogen ions in the acidic medium and also causes a reduction reaction (supplying electrons to the second electrode) with hydroxide ions in the basic medium. When the acidic and basic media can be spontaneously kept in a non-mixed state in the above case, a separation membrane is not necessarily needed.

The detection object substance serving as the oxidizer and the reducing agent is especially preferably hydrogen peroxide. The detailed reason for this will be described later.

Examples of a specimen to be sensed by the sensor of the invention include the following.
(1) Liquid which contains or may contain a detection object substance (hereafter simply referred to as liquid “containing a detection object substance” in this specification)
(2) Solid containing a detection object substance
(3) Liquid or solid which contains or may contain a substance releasing a detection object substance through chemical change or biochemical reaction (hereafter simply referred to as liquid or solid “containing a substance releasing a detection object substance through chemical change or biochemical reaction” in this specification).

Each of these specimens can be used in the following form in the sensor of the invention.
(1) In the case of liquid containing a detection object substance, the liquid is simply contained in the acidic and/or basic medium.
(2) In the case of solid containing a detection object substance, the solid is simply contained in the acidic and/or basic medium, or dissolved in liquid and the liquid is contained in the acidic and/or basic medium.
(3) In the case of liquid or solid containing a substance releasing a detection object substance through chemical change or a biochemical reaction, the liquid or solid is, for example, brought into contact with a reactant such as an enzyme and the resultant liquid containing the detection object substance is contained in the acidic and/or basic medium.

The “liquid” for the first and second substances may be in any form of solution (including as a solvent water and/or an organic solvent), dispersion liquid, or gel. The form of the liquid is appropriately selected to obtain a preferable combination of the liquid, and the acidic and basic media.

Also, these two substances may be added to the medium from a passage disposed in the vicinity of an electrode, may be added to the medium by using penetration into a capillary tube, or may be directly added to the medium. Alternatively, these two substances may be mixed with or dispersed in the medium before start of cell reaction of the sensor, or may be mixed with or dispersed in the liquid medium in advance.

First and Second Electrodes

In the invention, the first electrode is an anode (positive electrode), and the second electrode is a cathode (negative electrode). The materials of the first and second electrodes can be the same as or similar to those of the electrodes of conventional cells. Typical examples of the material of the first electrode (anode) include platinum, platinum black, platinum oxide, coated platinum, silver and gold. Moreover, titanium, stainless steel, nickel, and aluminum whose surfaces are passivated can also be used as the material of the first electrode. Furthermore, carbon structures such as graphite and carbon nanotube, amorphous carbon, and glassy carbon can also be used. Among these materials, platinum, platinum black, platinum oxide, and coated platinum are preferable from the viewpoint of durability.

Examples of the material of the second electrode (cathode) include platinum, platinum black, platinum oxide, coated platinum, silver and gold. Moreover, titanium, stainless steel, nickel, and aluminum whose surfaces are passivated can also be used as the material of the second electrode. Furthermore, carbon structures such as graphite and carbon nanotube, amorphous carbon, and glassy carbon can also be used. Among these materials, platinum, platinum black, platinum oxide, and coated platinum are preferable from the viewpoint of durability.

Further, in the invention, both of the first and second electrodes are preferably in the form of a plate, a thin film, a mesh, or fiber. The term “mesh” refers to a porous article having through-holes through which at least gas to be discharged can pass.

Specifically, the mesh-shaped electrode can be a metallic mesh, one in which the above-described electrode material is adhered to a punching metal plate or a foamed metal sheet by an electroless plating method, a vapor deposition method, or a sputtering method, one in which the electrode material is adhered to paper made of cellulose or a synthetic polymer by any of the above-described methods, or a combination thereof.

When the first and second electrodes are disposed in media having a high shape-retaining property such as an ion-exchange resin or ion-conductive gel, it is preferable to adhere a desired electrode material to the surface of the ion-exchange resin or the ion-conductive gel by an electroless plating method, a vapor deposition method, or a sputtering method.

Method of Detecting Substance

When the media contain a detection object substance, the sensor of the invention is a bipolar type cell. The mechanism through which voltage and current are generated in the bipolar type cell (power generation method) will be described in detail.

The power generation method uses the cell having the acidic medium, the first electrode that is disposed in the acidic medium, the basic medium in contact with the acidic medium, and the second electrode that is disposed in the basic medium. In the method, the first substance contained in the acidic medium causes a reaction of removing electrons from the first electrode with hydrogen ions, and the second substance contained in the basic medium causes a reaction of supplying electrons to the second electrode with hydroxide ions, thereby generating electric power. The first and second substances chemically change into substances having a lower internal energy, which releases, to the outside, energy substantially equal to that obtained by subtracting the total energy of these substances from the total energy of the first and second substances as electric energy to generate electric power.

Hereinafter, an embodiment will be explained in which the acidic medium is an acidic aqueous solution, in which the basic medium is a basic aqueous solution, and in which the first and second substances are hydrogen peroxide. The embodiment is the most preferable one of the invention, but the invention is not limited to this embodiment.

Hydrogen peroxide produces water and oxygen when it decomposes. When this chemical reaction is separated into an oxidation reaction and a reduction reaction which occur at separate electrodes, electromotive force is generated. Namely, hydrogen peroxide has an oxidizing function in an acidic reaction field and also has a reducing function in a basic reaction field, and electromotive force is thereby generated in the embodiment. Use of such an acid-base bipolar reaction field generates voltage and current between the electrodes. Hydrogen peroxide serving as the detection object substance is detected by a detector detecting the voltage and/or current.

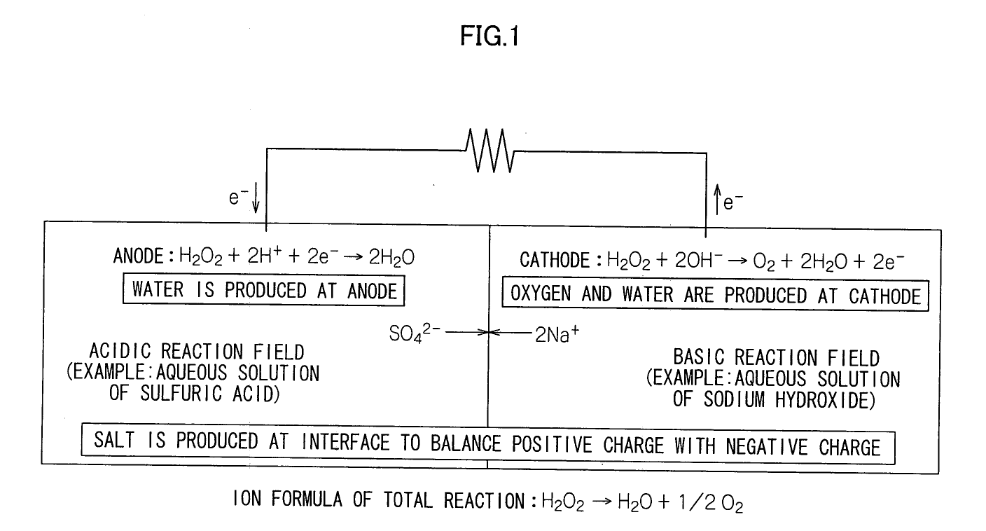

More specifically, the power generation method will be described with reference to FIG. 1. As shown in FIG. 1, hydrogen peroxide works as an oxidizer in the acidic reaction field (acidic medium) where an anode (first electrode) is disposed, and, as shown in the following Formula 1, the oxygen atoms of hydrogen peroxide receive electrons from the electrode to produce water. Meanwhile, hydrogen peroxide works as a reducing agent in the basic reaction field (basic medium) where the cathode (second electrode) is disposed, and, as shown in the following Formula 2, the oxygen atoms of hydrogen peroxide supply electrons to the electrode to produce oxygen and water. These reactions generate electromotive force to perform power generation.
H₂O₂(aq)+2H⁺+2e⁻→2H₂O Formula 1
H₂O₂(aq)+2OH⁻→O₂+2H₂O+2e⁻ Formula 2

In these formulae, the term “(aq)” represents a hydrated state.

A counter anion (sulfate ion SO₄²⁻ in FIG. 1) for the hydrogen ion present in the acidic medium and a counter cation (sodium ion Na⁺ in FIG. 1) for the hydroxide ion present in the basic medium form a salt at the interface of these media in the reaction field to balance positive charge with negative charge. The salt usually keeps an ion pair state in an aqueous solution, since the ions are more stable in the aqueous solution than the salt. Accordingly, the effect of salt formation on electromotive force in an oxidation or reduction reaction occurring at electrodes is extremely small. Therefore, the bipolar type cell of the invention in which an electrode reaction mainly occurs can more stably generate electricity than a bipolar type cell in which a neutralization reaction at the interface of the acidic and basic media mainly occurs (Electrochemistry 71, No. 5 (2003) 313-317).

An ionic reaction formula obtained by integrating the above-described half reaction formulae (Formulae 1 and 2) (case where balance of charge is held by ionic decomposition of water at the interface of the acidic and basic media) is shown in the following Formula 3.
H₂O₂(aq)→H₂O+½O₂ Formula 3

According to thermodynamic calculation, the enthalpy change (ΔH), the entropy change (ΔS), and the Gibbs free energy change (ΔG=ΔH−TΔS, T representing temperature whose unit is Kelvin (K)) of this reaction are −94.7 kJ/mol, 28 J/K mol, and −103.1 kJ/mol, respectively. Moreover, the theoretical electromotive force and the theoretical maximum efficiency (η) are respectively calculated from the formula of E=−ΔG/nF and the formula of η=ΔG/ΔH×100 and found to be 1.07 V and 109%, respectively. In the formulae, n is the number of electrons involved in the reaction, and F is a Faraday constant. The theoretical feature of this reaction is that the decomposition reaction of hydrogen peroxide increases entropy, whereby the sign of ΔS is positive. For this reason, the absolute value of ΔG is larger than ΔH, and thus the theoretical maximum efficiency exceeds 100%. In contrast to this, the sign of ΔS is negative in other fuel cell reactions such as a hydrogen-oxygen system or a direct methanol system.

When formation of a salt of a counter anion and a counter cation at the interface of the acidic and basic media balances positive charge with negative charge, an ionic reaction formula obtained by integrating the above-described half reaction formulae (Formulae 1 and 2) is shown in the following Formula 4.
H₂O₂(aq)+H⁺+OH⁻→2H₂O+½O₂ Formula 4

According to thermodynamic calculation, the enthalpy change (ΔH), the entropy change (ΔS), and the Gibbs free energy change (ΔG=ΔH−TΔS, T representing temperature whose unit is Kelvin (K)) of this reaction are −138 kJ/mol, 128 J/K mol, and −176 kJ/mol, respectively. Moreover, the theoretical electromotive force and the theoretical maximum efficiency (q) are respectively calculated from the formula of E=−ΔG/nF and the formula of η=ΔG/ΔH×100 and found to be 1.83 V and 128%, respectively. In the formulae, n is the number of electrons involved in the reaction, and F is a Faraday constant.

Hereinabove, the power generation method using hydrogen peroxide as the first and second substances has been described. A power generation method in which other substances are used as the two substances is substantially the same as the above power generation method in that a redox reaction is carried out at electrodes.

Hereinafter, preferable embodiments of the sensor of the invention will be described. However, the invention is not limited to these embodiments. The sensor of the invention is preferably a chip type sensor (1) described below, a paper type sensor in which a solid acidic medium is brought into contact with a solid basic medium, or a gel type sensor in which acidic ion-conductive gel is brought into contact with basic ion-conductive gel.

(1) Chip Type Sensor

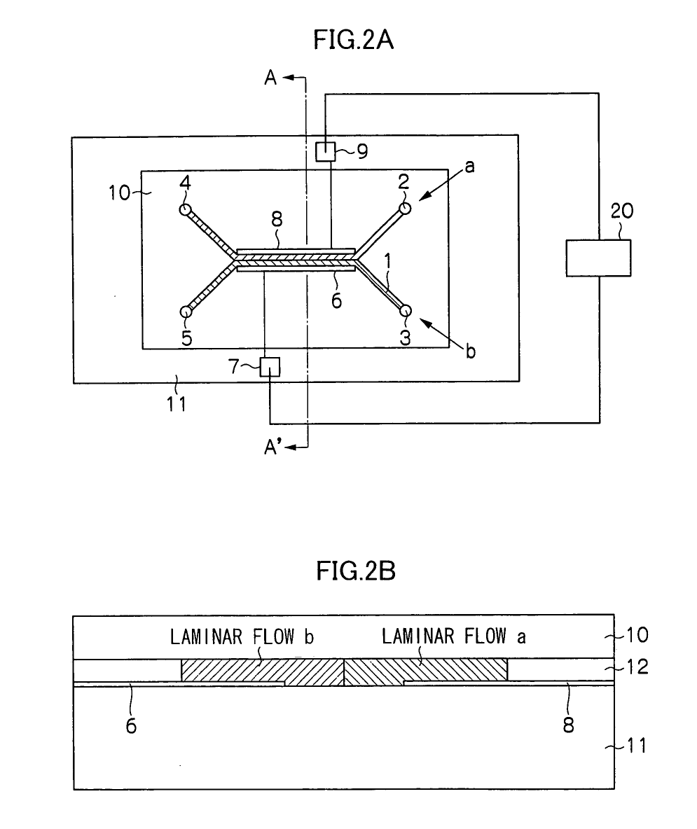

The chip type sensor has an acid-base bipolar reaction field in which liquid such as an aqueous solution of sulfuric acid is used as an acidic medium and in which liquid such as an aqueous solution of sodium hydroxide is used as a basic medium. The specific construction thereof will be described with reference to FIGS. 2A and 2B.

FIG. 2A is a top perspective view schematically showing a chip type sensor. As illustrated in FIG. 2A, the chip type sensor has a capillary passage 1 having a depth of 50 μm and a width of 1000 μm and formed between a slide glass 11, a cover glass 10 and a spacer (member 12 in FIG. 2B). This capillary passage 1 has inlets 2 and 3 from which a liquid acidic medium and a liquid basic medium are respectively introduced, and outlets 4 and 5 from which these media are respectively discharged. For example, when an acidic aqueous solution a and a basic aqueous solution b are made to be respectively introduced from the inlets 2 and 3 and to flow in the capillary passage 1, and when the viscosities and the flow speeds of the two liquids are suitable, laminar flows (Reynolds flow) occur at the confluence portion of the capillary passage 1.

This laminar flows will be described with reference to FIG. 2B. FIG. 2B is a cross-sectional view obtained by cutting the chip type sensor of FIG. 2A along the line A-A′. As illustrated in FIG. 2B, the acidic aqueous solution a and the basic aqueous solution b respectively form laminar flows a and b, which flow in the capillary passage 1 so that they are in contact with each other without mixing, at the confluence portion of the capillary passage 1. The formed laminar flows a and b flow in the confluence portion and separate out at a branching point, and the acidic aqueous solution a and the basic aqueous solution b are respectively discharged from the outlets 4 and 5 and independently collected.

Two platinum electrodes 6 and 8 are disposed at the bottom of the confluence portion of the capillary passage 1, in which such laminar flows are formed, and electrically connected to a detector 20 such as a voltammeter via connection terminals 7 and 9. The detector 20 detects (measures) voltage and/or current generated between the electrodes 6 and 8 by detection object substances contained in the acidic aqueous solution a and the basic aqueous solution b. When the presence or absence of the detection object substance is simply to be detected, the detector 20 can be a detection member (for example, a light-emitting diode or a buzzer) that is driven by the voltage and/or current generated between the electrodes 6 and 8. When such a detector emits light or sounds, it is found that a detection object substance is contained in the aqueous solutions.

Application of the characteristics of viscous fluid in a capillary passage can realize formation of laminar flows, in which two liquids are in contact with each other and do not mix. This is a phenomenon (Reynolds flow phenomenon) that takes place when a constant Reynolds number (Re) dependent on the viscosity and flow speed of liquid and the shape of a passage (the diameter of a tube, or the width or depth of the passage) is less than or equal to about 2000. Use of this phenomenon causes two liquids having a suitable viscosity and a suitable movement speed to form laminar flows in a capillary tube and to hardly mix with each other. For this reason, when electrodes are placed in the laminar flows in which first and second substances coexist, an oxidation reaction occurs in the acidic medium and a reduction reaction occurs in the basic medium to generate electromotive force.

A capillary passage having a complex structure can be easily fabricated by applying an existent processing technique such as supersonic grinding, semiconductor photolithography, sandblasting, injection molding, or silicone resin molding to a substrate (chip) made of glass, quartz, silicon, polymer film, plastic resin, ceramic, graphite, or metal. A composite sensor capable of detecting plural detection objects can be manufactured by integrating unit sensors and stacking plural chips.

When hydrogen peroxide is used as the detection object substance in the sensor of the invention, disposing an enzyme reaction unit which generates hydrogen peroxide from a biosubstance such as glucose or urea on an upstream side of the sensor enables detection of the biosubstance. Further, a sensor that would not need a power source, i.e. a kind of a self-standing sensor, can be constructed by operating the detector itself with the output voltage of the sensor.

Moreover, when, for example, the voltage-current characteristic with respect to the concentration of a detection object substance (calibration curve with respect to substance concentration) is obtained in advance, accurate concentration measurement can be carried out.

Further, when the first and second substances serving as detection object substances are different from each other, or when the first and second substances are the same detection object substance but have different concentrations, and when the kind or concentration of one of the first and second substances is known, the kind or concentration of the other can be detected.

Although the sensor of the invention and the embodiments thereof have been described hereinbefore, the invention is not limited to these constructions and applications. For example, a sensor having the above-described construction can be combined with a conventional sensor.

### EXAMPLES

Hereinafter, the effect of the invention will be described more specifically by way of Examples of chip type sensors. A similar effect is produced by a sensor including the aforementioned ion-conductive gels. Further, the invention is not limited to these Examples.

### Example 1

Output (power generation) experiments are conducted on a chip type sensor shown in FIG. 2 under conditions described below, and the hydrogen peroxide concentration-current/voltage characteristics are obtained and the sensor is evaluated. For preparatory experiments, each of sample liquids A₀ are prepared by mixing an aqueous solution of hydrogen peroxide having a special grade and a concentration of 35% and manufactured by Kanto Chemical Co., Ltd. with sulfuric acid having a special grade and a concentration of 96% and manufactured by Kanto Chemical Co., Ltd. and distilled water. The concentration of the sulfuric acid in the sample liquids A₀ is 0.1 N normal (0.05 mol/liter). Moreover, each of sample liquids B₀ are prepared by mixing the same aqueous solution of hydrogen peroxide with sodium hydroxide having a special grade and a concentration of 97% and manufactured by Kanto Chemical Co., Ltd. and distilled water. The concentration of the sodium hydroxide in the sample liquids B₀ is 0.1 N normal (0.1 mol/liter). The concentrations of hydrogen peroxide contained in the sample liquids A₀ are adjusted at 0 mol/liter, 10 μmol/liter, 100 μmol/liter, and 200 μmol/liter, respectively. Further, the concentrations of hydrogen peroxide contained in the sample liquids B₀ are adjusted at 0 mol/liter, 10 μmol/liter, 100 μmol/liter, and 200 μmol/liter, respectively. A sample liquid A₀ and a sample liquid B₀ having the same hydrogen peroxide concentration are used together.

The sample liquids A₀ and B₀ are respectively injected from the inlets 2 and 3 into the chip type sensor with an external pump. The flow speeds of the sample liquids are both 24 μl/second (Reynolds number Re of about 670) at the central portion of the passage, and the experiment temperature is room temperature. An electrode 8 (platinum thin film having an area of 0.026 cm²) on the bottom surface of a portion of the passage which portion is in contact with the sample liquid A₀ works as an anode, and an electrode 6 (platinum thin film having an area of 0.026 cm²) on the bottom surface of a portion of the passage which portion is in contact with sample liquid B₀ works as a cathode to form a cell, and electromotive force (sensor output) is generated.

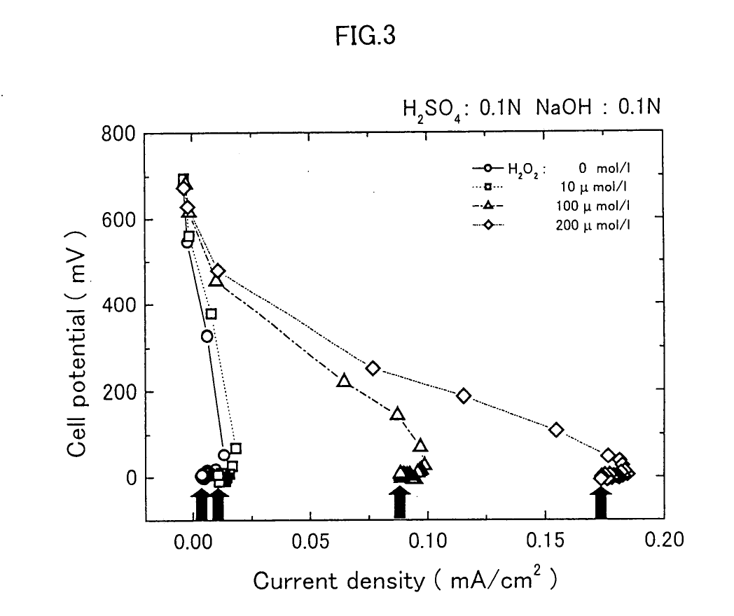

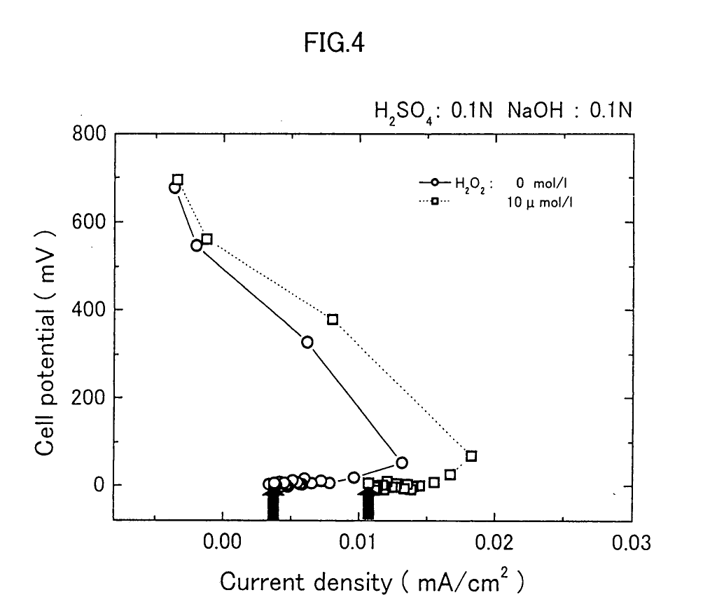

While the value of resistance of an external resistor electrically connected to the sensor with the cell construction is changed within a range from 0 Ω to 1 MΩ under the experiment conditions, the current-voltage characteristics when the sensor is used with combinations of the sample liquids A₀ and B₀ are measured with a digital multimeter (2000 manufactured by KEITHLEY). The results thereof are shown in FIGS. 3 and 4. FIG. 4 is an enlarged view showing the current-voltage characteristics in a range where current density is low in FIG. 3. However, FIG. 4 shows only cases of hydrogen peroxide concentration being 0 mol/liter and 10 μmol/liter. Further, the current value (the closed-circuit current density) when the value of resistance of the external resistor is the lowest in each case is shown by an arrow in FIGS. 3 and 4.

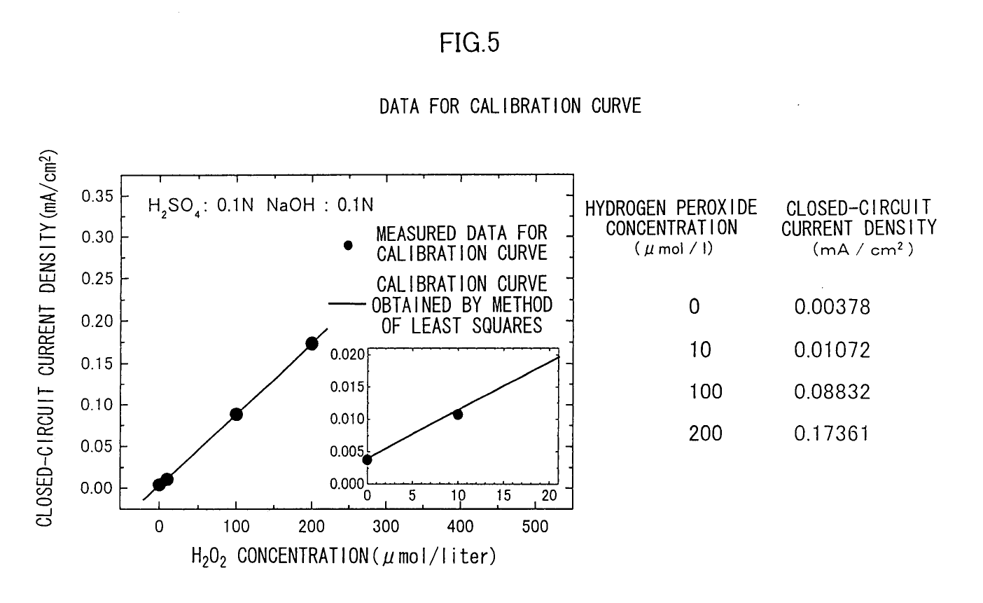

In FIG. 5, the closed-circuit current densities in FIGS. 3 and 4 are plotted with respect to hydrogen peroxide concentrations. A graph inserted in FIG. 5 is an enlarged graph of a range where the hydrogen peroxide concentration is low. These date are used as those for a calibration curve, and a calibration curve is drawn on the basis of these data and a method of least squares.

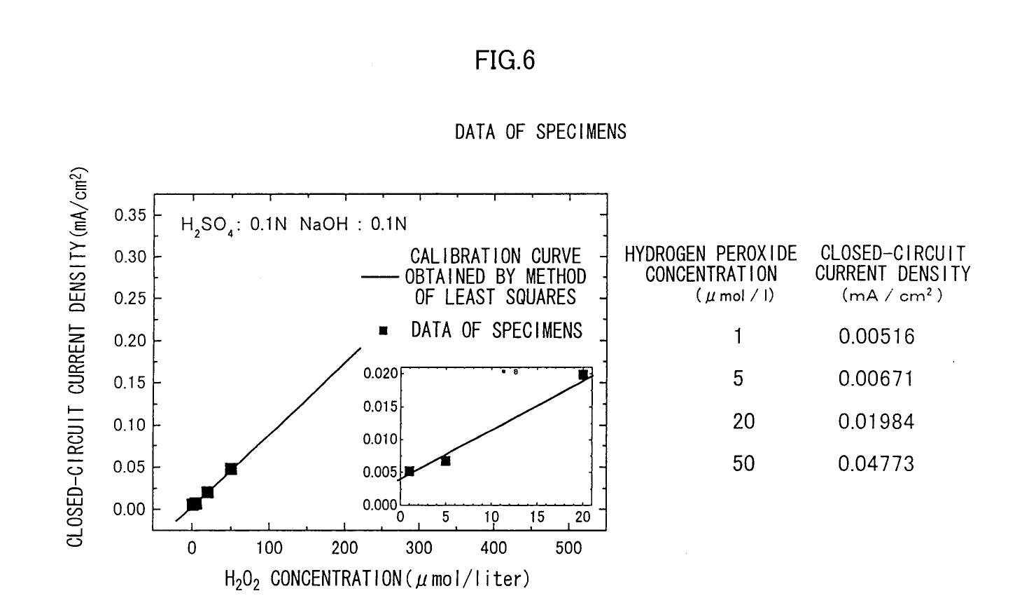

Meanwhile, sample liquids A₁ and B₁ having hydrogen peroxide concentrations of 1 μmol/liter, 5 μmol/liter, 20 μmol/liter, and 50 μmol/liter are prepared. The concentration of the sulfuric acid in the sample liquids A₁ is 0.1 N normal (0.05 mol/liter). Moreover, the concentration of the sodium hydroxide in the sample liquids B₁ is 0.1 N normal (0.1 mol/liter). Closed-circuit current densities when the sensor is used with specimens combining one sample liquid A₁ and one sample liquid B₁ having the same hydrogen peroxide concentration are measured in order to conduct actual experiments (evaluate the sensor). The measured values are plotted with respect to hydrogen peroxide concentrations in FIG. 6. These values are regarded as specimen data, and are on the calibration curve of FIG. 5.

From FIGS. 5 and 6, it has been confirmed that closed circuit current density increases monotonously when sample liquids A₀ and B₀ having a wide range of hydrogen peroxide concentration from 1 μmol/liter to 200 μmol/liter are used. Also, it has been confirmed that, when a calibration curve is prepared and used, the concentrations (about several μmol/liter to several hundred μmol/liter) of hydrogen peroxide contained in the specimen solutions A₁ and B₁ can be easily determined.

### Example 2

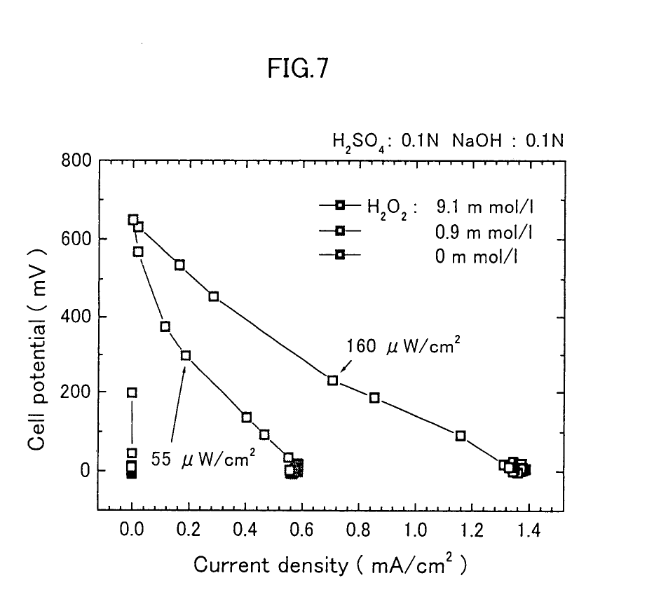

The chip type sensor of Example 1 is evaluated in the same manner as in Example 1, except that the sample liquids A₁ and B₁ are replaced with sample liquids A₁′ and B₁′ having hydrogen peroxide concentrations of 0 mol/liter, 0.9 mmol/liter, and 9.1 mmol/liter. The concentration of the sulfuric acid in the sample liquids A₁′ is 0.1 N normal (0.05 mol/liter) and the concentration of sodium hydroxide in the sample liquids B₁′ is 0.1 N normal (0.1 mol/liter). The flow speed and the experiment temperature are the same as in Example 1. The current-voltage characteristics of the sensor under such experiment conditions are shown in FIG. 7. In Example 2, when the hydrogen peroxide concentration is 0.9 mmol/liter, a closed-circuit current density of 0.56 mA/cm² is obtained. Moreover, when the hydrogen peroxide concentration is 9.1 mmol/liter, a closed-circuit current density of 1.35 mA/cm² is obtained.

### Example 3

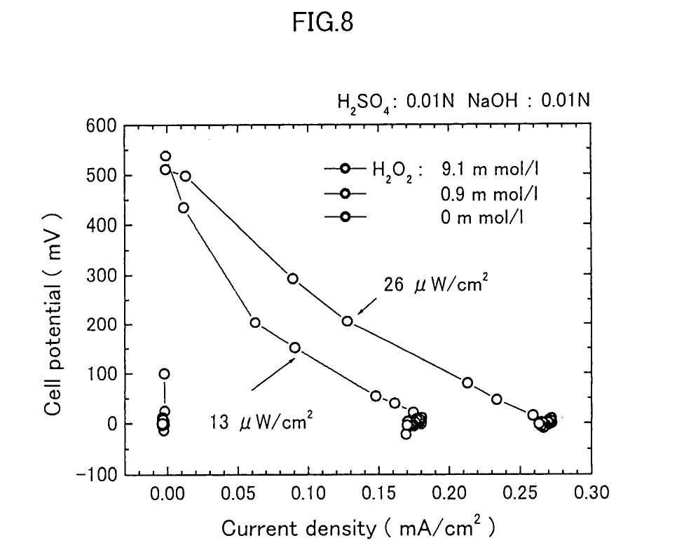

The chip type sensor of Example 1 is evaluated in the same manner as in Example 1, except that the sample liquids A₁ and B₁ are replaced with sample liquids A₁″ and B₁″ having hydrogen peroxide concentrations of 0 mol/liter, 0.9 mmol/liter, and 9.1 mmol/liter, and that the concentration of the sulfuric acid in the sample liquids A₁″ is 0.01 N normal (0.005 mol/liter), and that the concentration of sodium hydroxide in the sample liquids B₁″ is 0.01 N normal (0.01 mol/liter). The flow speed and the experiment temperature are the same as in Example 1. The current-voltage characteristics of the sensor under such experiment conditions are shown in FIG. 8. In Example 3, when the hydrogen peroxide concentration is 0.9 mmol/liter, a closed-circuit current density of 0.18 mA/cm² is obtained. Moreover, when the hydrogen peroxide concentration is 9.1 mmol/liter, a closed-circuit current density of 0.26 mA/cm² is obtained.

According to Examples described above, the voltage-current characteristics dependent on the hydrogen peroxide concentration are obtained in a wide range from about several μmol/liter to ten mmol/liter, as shown in FIGS. 3, 7, and 8. Further, a good corresponding relationship between closed-circuit current density and hydrogen peroxide concentration is obtained. It has been confirmed that preparation of a calibration curve enables easy determination of the hydrogen peroxide concentration of a specimen solution prepared separately (See FIGS. 5 and 6). Thus, it has been confirmed that the sensor of these Examples having a simple construction can precisely detect a detection object substance.

1. A sensor for detecting, as at least one detection object substance, at least one of a first substance and a second substance, the sensor comprising:
an acidic medium;
a first electrode disposed in the acidic medium;
a basic medium adjacent to or close to the acidic medium;
a second electrode disposed in the basic medium; and
a detector for detecting one of voltage and current that is generated between the first and second electrodes by the first substance which causes a reaction of removing electrons from the first electrode with hydrogen ions contained in the acidic medium, and the second substance which causes a reaction of supplying electrons to the second electrode with hydroxide ions contained in the basic medium.

2. The sensor of claim 1, wherein the first substance and the second substance are the same substance.

3. The sensor of claim 2, wherein the first substance and the second substance are both hydrogen peroxide.

4. The sensor of claim 1, wherein the acidic medium is an acidic aqueous solution and the basic medium is a basic aqueous solution.

5. The sensor of claim 4, comprising a passage structure within which the acidic aqueous solution and the basic aqueous solution form laminar flows.

6. The sensor of claim 4, wherein the acidic aqueous solution contains one or more acids selected from the group consisting of sulfuric acid, methanesulfonic acid, trifluoromethanesulfonic acid, hydrochloric acid, hydriodic acid, hydrobromic acid, perchloric acid, periodic acid, orthophosphoric acid, polyphosphoric acid, nitric acid, tetrafluoroboric acid, hexafluorosilic acid, hexafluorophosphoric acid, hexafluoroarsenic acid, hexachloroplatinic acid, acetic acid, trifluoroacetic acid, citric acid, oxalic acid, salicylic acid, tartaric acid, maleic acid, malonic acid, phthalic acid, fumaric acid, and picric acid.

7. The sensor of claim 4, wherein the basic aqueous solution contains one or more bases selected from the group consisting of sodium hydroxide, potassium hydroxide, lithium hydroxide, calcium hydroxide, barium hydroxide, magnesium hydroxide, ammonium hydroxide, tetramethylammonium hydroxide, tetraethylammonium hydroxide, tetrapropylammonium hydroxide, and tetrabutylammonium hydroxide, or contains one or more alkali metal salts of weak acids selected from the group consisting of sodium carbonate, sodium hydrogen carbonate, potassium carbonate, potassium hydrogen carbonate, sodium borate, potassium borate, sodium silicate, potassium silicate, sodium tripolyphosphate, potassium tripolyphosphate, sodium aluminate, and potassium aluminate.

8. The sensor of claim 1, wherein the acidic medium includes an acidic ion-exchange member, and the basic medium includes a basic ion-exchange member.

9. The sensor of claim 8, wherein the acidic and basic ion-exchange members are selected from the group consisting of polyvinylstyrene ion-exchange resin, polyfluorohydrocarbon polymer electrolyte membrane, polyvinylstyrene ion-exchange membrane, and fibrous polystyrene ion-exchange filter paper.

10. The sensor of claim 1, wherein the acidic medium includes an acidic ion-conductive gel, and the basic medium includes a basic ion-conductive gel.

11. The sensor of claim 10, wherein the acidic ion-conductive gel is formed by gelatinizing an acidic aqueous solution with water glass, anhydrous silicon dioxide, cross-linked polyacrylic acid, agar, or a salt thereof.

12. The sensor of claim 10, wherein the basic ion-conductive gel is formed by gelatinizing a basic aqueous solution with carboxymethyl cellulose, cross-linked polyacrylic acid, or a salt thereof.

13. The sensor of claim 1, wherein the first electrode comprises one or more materials selected from the group consisting of platinum, platinum black, platinum oxide, coated platinum, silver, gold, surface-passivated titanium, surface-passivated stainless steel, surface-passivated nickel, surface-passivated aluminum, carbon structure, amorphous carbon, and glassy carbon.

14. The sensor of claim 1, wherein the second electrode comprises one or more materials selected from the group consisting of platinum, platinum black, platinum oxide, coated platinum, silver, gold, surface-passivated titanium, surface-passivated stainless steel, surface-passivated nickel, surface-passivated aluminum, carbon structure, amorphous carbon, and glassy carbon.

15. The sensor of claim 1, wherein both of the first electrode and the second electrode are plate-shaped, thin-film-shaped, mesh-shaped, or fibrous.

16. The sensor of claim 1, wherein the first electrode and the second electrode are respectively disposed in the acidic medium and in the basic medium by an electroless plating method, a vapor deposition method, or a sputtering method.

17. A method of detecting a substance comprising:
providing a sensor comprising an acidic medium, a first electrode disposed in the acidic medium, a basic medium adjacent to or close to the acidic medium, a second electrode disposed in the basic medium, and a detector for detecting one of voltage and current that is generated between the first and second electrodes by a first substance which causes a reaction of removing electrons from the first electrode with hydrogen ions contained in the acidic medium, and a second substance which causes a reaction of supplying electrons to the second electrode with hydroxide ions contained in the basic medium; and
using the sensor to detect at least one of the first and second substances as at least one detection object substance.
